(19) United States
(12) Patent Application Publication
(10) Pub. No.: US 2011/0031294 A1
(43) Pub. Date: Feb. 10, 2011

(54) Anti Theft Bag with Locator

(76) Inventor: Cassius Q. Booth, Oakland, CA (US)

Correspondence Address: PATWRITE LLC, 408 W. MAIN ST., MARSHALLTOWN, IA, 50158-5759, US

(21) Appl. No.: 12/537,308

(22) Filed: Aug. 7, 2009

(51) Int. Cl. A45C 15/00; G01S 19/16; B65D 55/14; E05B 37/00

(52) U.S. Cl. 224/576; 70/158; 70/22; 342/357.54

(57) ABSTRACT

An anti-theft bag with locator has a bag portion with a flap portion that can be closed to secure the contents of the bag. A lock-locator is provided to secure the flap to prevent casual opening of the bag. The lock-locator also contains a GPS component that allows a user to track the bag if stolen or lost. In one embodiment a remote control turns the GOS functionality on and off. The position of the bag is displayed in real-time on a network enabled appliance such as a cell phone, netbook or computer. The lock-locator is a combination lock with rotating disks disposed within the circular perimeter therein. In one embodiment, the power source is located within the lock-locator. In another embodiment, a power source is disposed within the bag and is not visible. The front of the lock-locator may be esthetically enhanced by having initials, logos or other graphic.

### BACKGROUND OF THE INVENTION

Humans have the great advantage of being able to use tools to impact their environment. Along with this advantage means necessarily that we will want to carry things with us. It is important to be able use our hands and not to have to grasp the items in the hand. Many methods of being able to carry things while not having to grasp them have been developed. Among them; pockets, purses, backpacks, etc. Purses, bags and backpacks, while holding objects very effectively, are subject to being stolen and their recovery is difficult since they are necessarily quite portable.

There is a need for a bag that allows a user to effectively hold items while deterring theft and also allowing the user to easily locate the bag if misplaced.

### SUMMARY OF THE INVENTION

An anti-theft bag with locator has a bag portion with a flap portion that can be closed to secure the contents of the bag. A lock-locator is provided to secure the flap to prevent casual opening of the bag. The lock-locator also contains a GPS component that allows a user to track the bag if stolen or lost. In one embodiment a remote control turns the GOS functionality on and off. The position of the bag is displayed in real-time on a network enabled appliance such as a cell phone, netbook or computer. The lock-locator is a combination lock with rotating disks disposed within the circular perimeter therein. In one embodiment, the power source is located within the lock-locator. In another embodiment, a power source is disposed within the bag and is not visible. The front of the lock-locator may be esthetically enhanced by having initials, logos or other graphic.

Other features and advantages of the instant invention will become apparent from the following description of the invention which refers to the accompanying drawings.

### BRIEF DESCRIPTION OF THE DRAWINGS

FIG. 1 is a front view of an anti-theft bag with locator according to an embodiment of the invention.

FIG. 2 is a side view of an anti-theft bag with locator according to an embodiment of the invention.

FIG. 3 is a front close up view of the locator lock shown in FIG. 1.

FIG. 4 is a side close up view of the locator lock shown in FIG. 2.

FIG. 5 is a top view of a remote for use with anti-theft bag with locator according to an embodiment of the invention.

FIG. 6 is an illustration of a tracking function according to an embodiment of the present invention.

FIG. 7 is an illustration of a tracking function as implemented in a mobile device.

FIG. 8 is a side cutaway view of the anti-theft bag with locator shown in FIG. 2.

FIG. 9 is a perspective view of a charging base and locator lock according to an embodiment of the present invention.

### DETAILED DESCRIPTION OF THE INVENTION

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

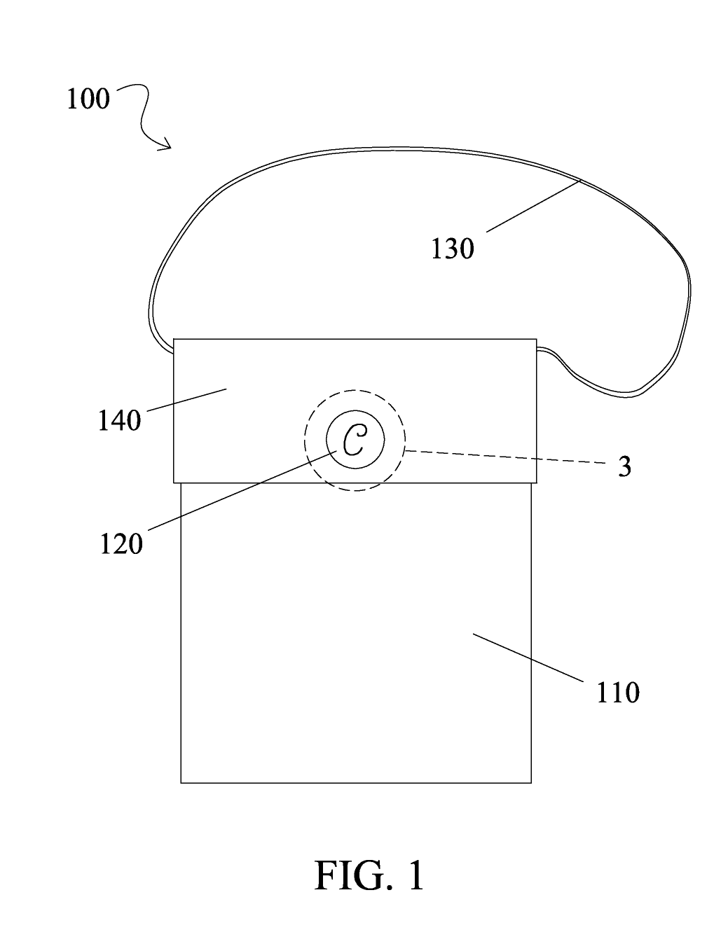

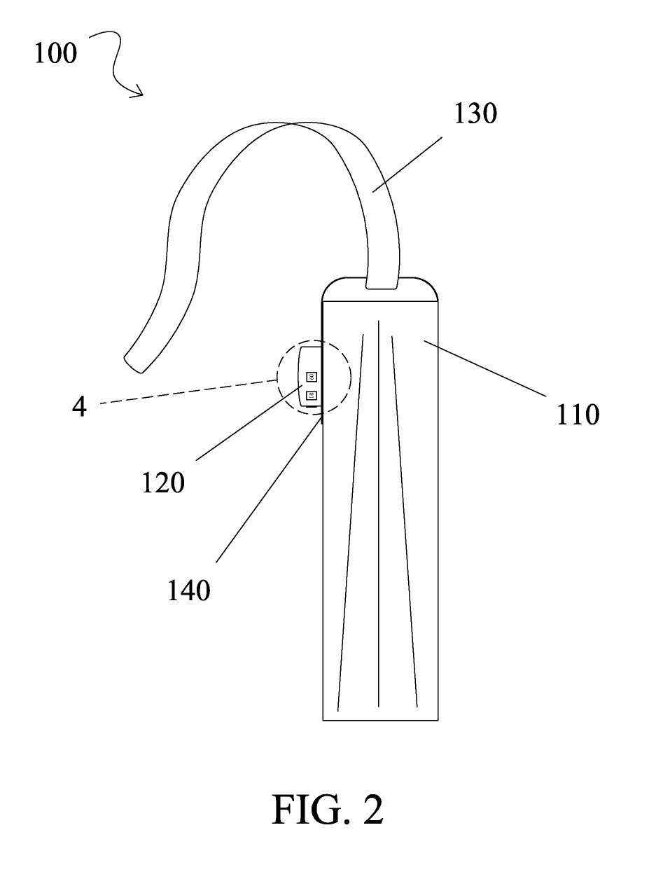

Referring to FIGS. 1 and 2, an anti-theft bag with locator 100 is shown having a bag portion 110, a flap portion 140, strap 130 and a lock-locator 120 disposed on flap portion 140. Of course although bag portion 110 is shown rectangular, it is understood that any suitable shaped bag is suitable as long as the bag can be fitted with lock-locator 120. Additionally, bag 100 may be a book bag or backpack. Bag 100 is made of materials such as leather, fabric or combination. Synthetic materials may be used. Strap 130 may be adjustable as is known in the art.

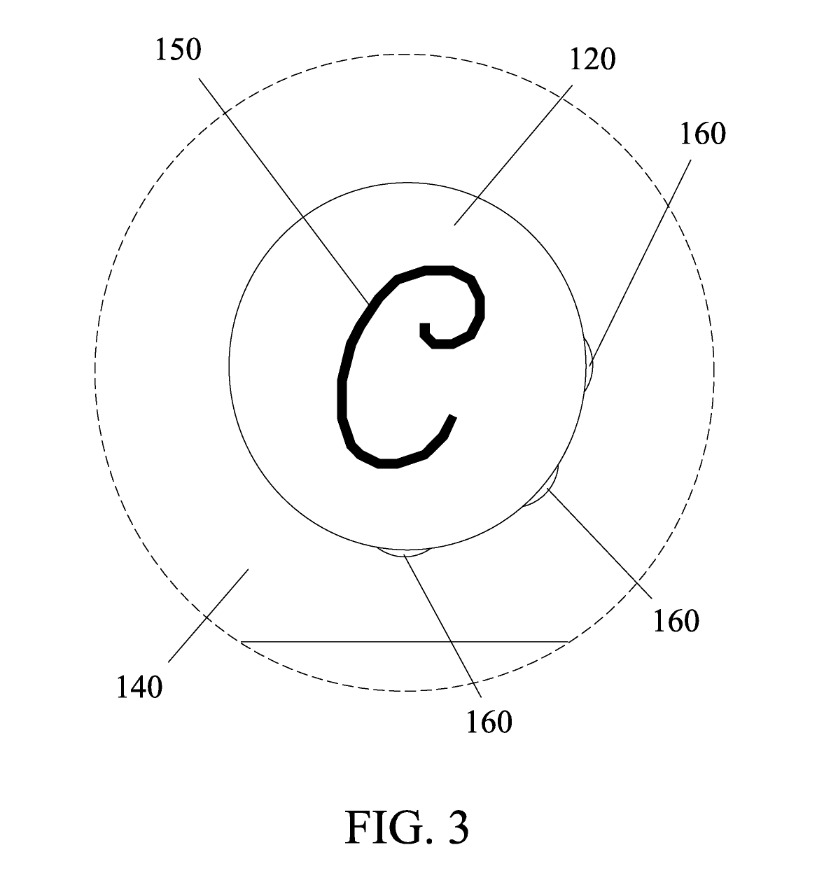

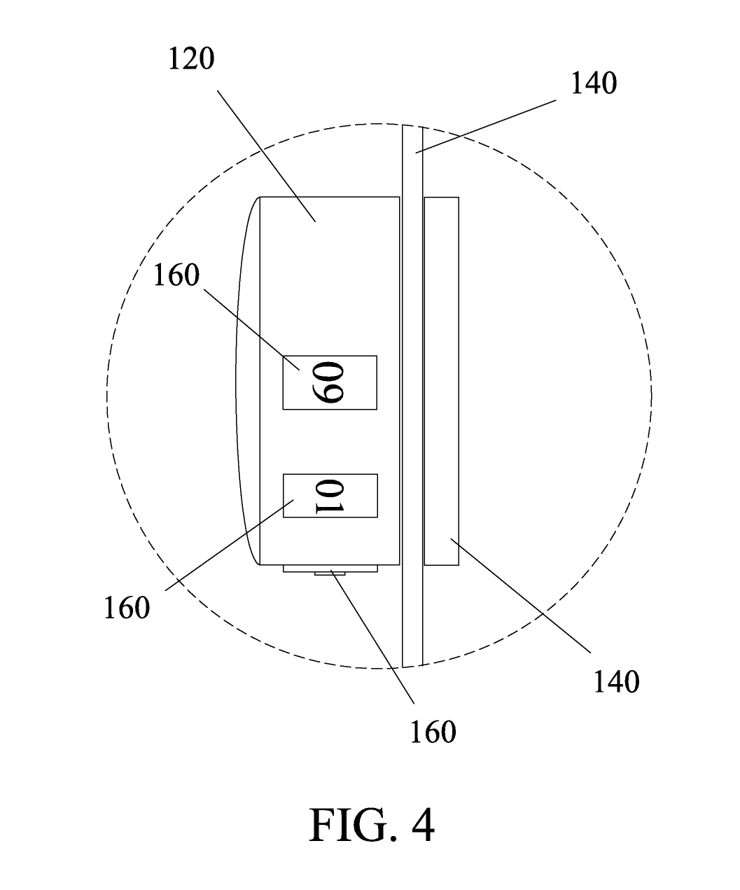

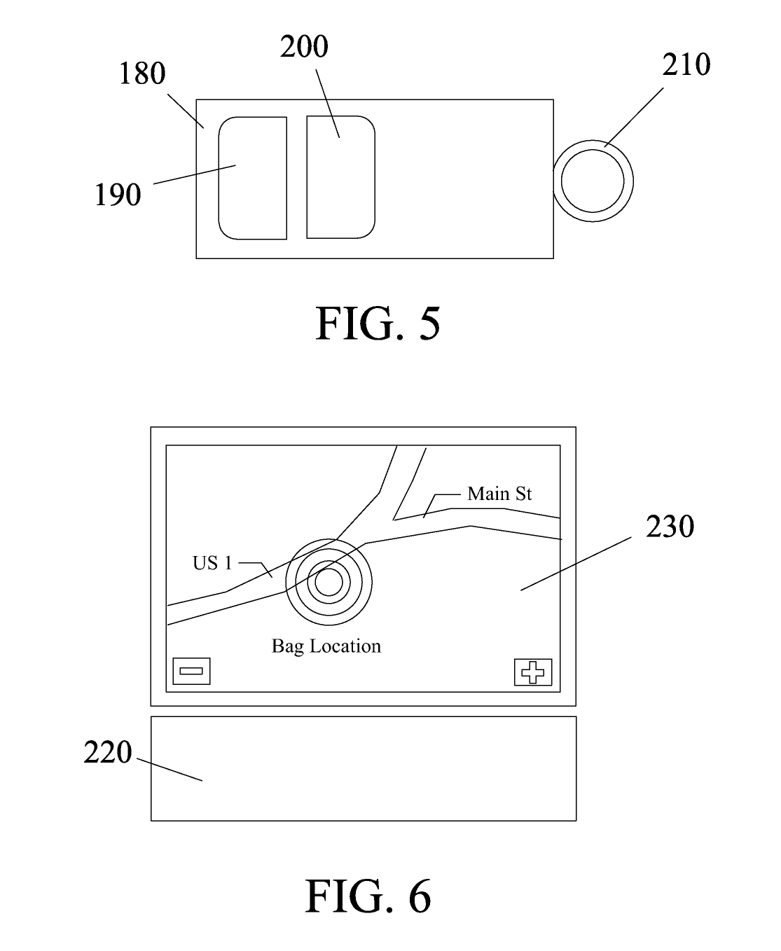

Referring now to FIGS. 1 through 5, lock-locator 120 is a combination lock with a series of three rotating cylinders 160 that are used to uniquely code a combination to deter casual theft. Additionally, should the bag be stolen or simply misplaced, a GPS function is built in to lock-locator 120 that is remotely activated using remote 180 or manually activated by an activation means (not shown). Once activated, lock-locator 120 may be tracked using an appropriate interface. Remote 180 has a key ring 210 attachment portion to allow a user to conveniently carry remote 180. Remote 180 has an activation button 190 and a de-activation button 200. The circuitry (not shown) and power supply (not shown) for remote 180 is known in the art. GPS functionality is provided by a miniaturized GPS chip disposed within lock-locator 120. The GPS circuitry is known in the art and is adapted to fit therein.

Lock-locator 120 may be customized with a monogram 150 or other decorative design to enhance that esthetic look. Additionally promotional designs or logos may be used.

Referring now to FIG. 6, a graphical interface 230 is shown displayed on an electronic device 232 such as a computer, network appliance or other device as is known in the art. Once activated, lock-locator will allow a user to track the location of bag 100. The user can provide the information to law enforcement if the bag is stolen.

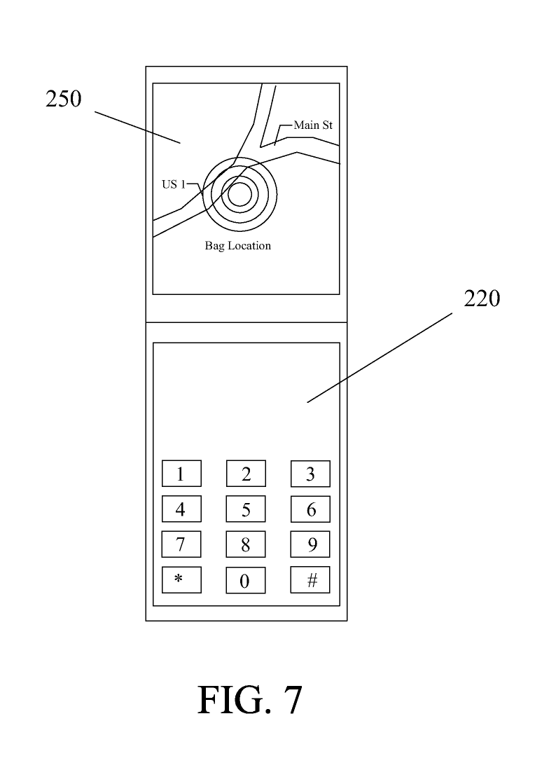

FIG. 7 shows a mobile device 220 such as a cell phone provided with a location application that resides in or is available to device 220 and displays the location of bag 100 using a graphical interface 250. The GPS feature allows bag 100 to be traced even if it is currently moving by showing the route on a superimposed map. Mobile device 220 may be a cell phone, netbook, Blackberry® devices or other network appliance as is known in the art.

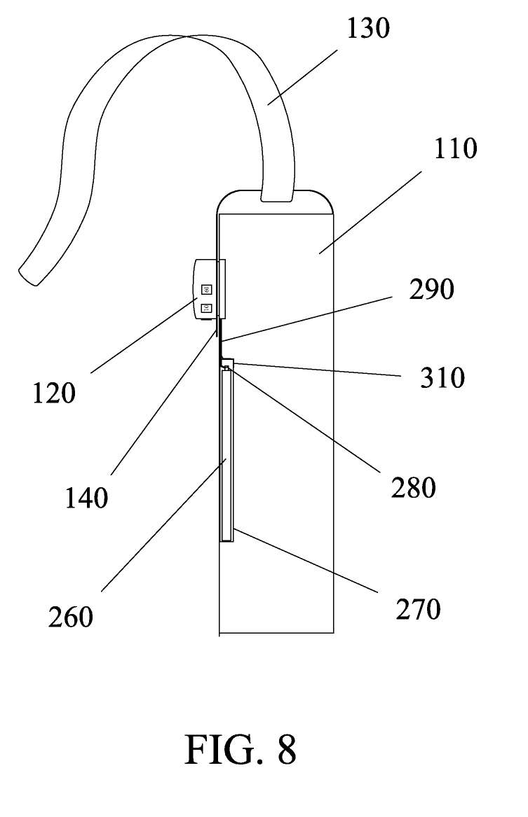

Referring to FIG. 8, bag portion 110 is shown having a power source 260 disposed within a pouch 270 sewn within bag portion 110. Power source 260 has electrical connectors 280 and wires 290 to electrically connect power source 260 to GPS enabled lock-locator 120. Power source 260 may be removably retained within pouch 270 by a hook and loop fastener 310 or other suitable closure means. Power source 260 is a rechargeable battery such as Ni-MH, Li-ion or other rechargeable power sources as is known in the art. Of course power source 260 may be located in another location as is known in the art.

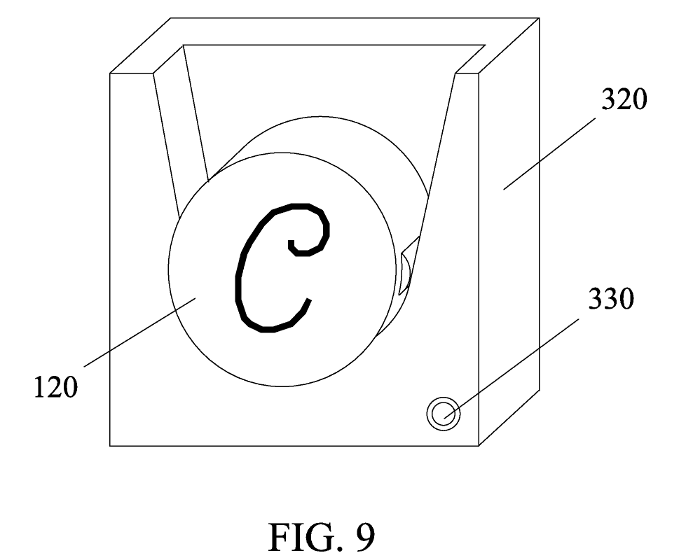

Referring now to FIG. 9, a rechargeable base 320 is shown cradling lock-locator 120 to recharge a battery (not shown) disposed within lock-locator 120. A charge indicator light 330 indicates when fully charged or alternatively, shows a power on condition. In this embodiment, lock-locator is removed from bag 100 and placed in recharge cradle 320 to prepare for use.

Other uses for bag 100 may be for use with monetary transfers such as money bags used by armored cars to transfer money between geographic locations. In a money bag embodiment, the flap would completely secure the contents with lock-locator being use to secure and locate bag if stolen.

Although the instant invention has been described in relation to particular embodiments thereof, many other variations and modifications and other uses will become apparent to those skilled in the art.

What is claimed is:

1. An anti-theft bag with locator comprising:
a bag portion;
said bag portion having a closable flap for securing an open portion of said bag portion;
a lock adapted to selectively secure said flap portion to said open portion;
said lock having a GPS means disposed within; and
said lock also containing a power source in electrical communication with said GPS means.

2. The anti-theft bag with locator according to claim 1 further comprising a remote control adapted to control said GPS means.

3. The anti-theft bag with locator according to claim 1 further comprising a graphical interface means adapted for displaying a position of said GPS means whereby a user can locate said anti-theft bag with locator.

4. The anti-theft bag with locator according to claim 1 wherein said lock is a combination lock.

5. The anti-theft bag with locator according to claim 4 further comprising a plurality of rotating disks disposed within an outer perimeter of said lock wherein said lock opens when said rotating disks are arranged in a selected order.

6. The anti-theft bag with locator according to claim 3 wherein said graphical interface means is a network enabled appliance.

7. The anti-theft bag with locator according to claim 3 wherein said graphical interface means is a cellular phone.

8. The anti-theft bag with locator according to claim 1 wherein said bag portion is a backpack.
The anti-theft bag with locator according to claim 1 further comprising a power source disposed within said bag portion wherein said GPS means is electrically activated.

9. The anti-theft bag with locator according to claim 1 further comprising a recharging cradle adapted to recharge said power source.
